(19) United States
(12) Patent Application Publication
(10) Pub. No.: US 2019/0047377 A1
(43) Pub. Date: Feb. 14, 2019

(54) AIR CONDITIONING BLOWER HOLE APPARATUS

(71) Applicant: MORIROKU TECHNOLOGY COMPANY, LTD., Tokyo (JP)

(72) Inventors: Takashi Tanaka, Tokyo (JP); Yusuke Fukuda, Tokyo (JP)

(21) Appl. No.: 16/055,476

(22) Filed: Aug. 6, 2018

(30) Foreign Application Priority Data
Aug. 8, 2017 (JP) 2017-153409

(51) Int. Cl. B60H 1/34; F24F 13/15

(52) U.S. Cl. CPC B60H 1/3428; F24F 13/15; B60H 2001/3492; B60H 2001/3471; B60H 2001/3464

(57) ABSTRACT

An air conditioning blower hole apparatus is provided which is capable of suppressing a looseness of a fin, and of decreasing production costs. This air conditioning blower hole apparatus includes: a plurality of fins; and a link coupled with the plurality of fins. At least one fin includes: a fin body; a large-diameter shaft part extending from the fin body; a small-diameter shaft part extending from the large-diameter shaft part, and having a smaller diameter than a diameter of the large-diameter shaft part; and a retainer part provided at a tip of the small-diameter shaft part, and having a larger diameter than the small-diameter shaft part. The link is provided with a large-diameter hole corresponding to the large-diameter shaft part and a small-diameter hole corresponding to the small-diameter shaft part. A gap is secured between the small-diameter shaft part and the small-diameter hole.

### FIELD OF THE INVENTION

The present disclosure relates to a fin apparatus provided at a blower hole of an automobile or vehicular air conditioning device.

In particular, the present disclosure relates to a blower hole apparatus which has plurality of fins provided in parallel with each other within a ventilation channel, and which adjusts the direction of blown air by rotating the fins.

### BACKGROUND

In this specification, the term “contact-slide” means when a member moves relative to another member, the member moves along a contact surface with the member being in contact with another member.

JP H08-113029 A and JP 2006-015840 A disclose an air conditioning blower hole apparatus for an automobile.

According to JP H08-113029 A, the plurality of fins include at least one first fin, and a remaining second fin.

A coupling shaft of the second fin is formed in a shape that includes a cylindrical shaft part and a circular head part with a larger dimension than that of the cylindrical shaft part.

In contrast, a coupling shaft of the first fin is formed in a cylindrical shape that has a larger diameter and is longer than those of the coupling shaft of the second fin.

Moreover, at least one first engagement hole among the engagement holes of a coupling member is formed in a circular shape that has a larger diameter and is longer than those of a second engagement hole so as to correspond to the diameter of the coupling shaft of the first fin and the shaft length thereof.

The coupling shaft of the first fin is smoothly fitted in the first engagement hole of the coupling member, preventing a deformation of the first engagement hole. This enables the first engagement hole and the coupling shaft of the first fin to maintain the contact-slide condition, ensuring a sliding friction as originally set.

In contrast, the coupling shaft of the second fin has the head part. When the second engagement hole of the coupling member is attached to the coupling shaft of the second fin, after the head part passes through, the second engagement hole is engaged with the coupling shaft of the second fin. The second engagement hole changes elastically the hole diameter. However, the action enlarged by the head part remains, and thus the diameter inevitably becomes large.

The enlarged second engagement hole decreases the sliding friction between the coupling shaft of the second fin and the second engagement hole. In a more air-volume mode, the air volume increases. when the sliding friction is small, it is difficult to maintain the second fin at a desired position in the more air-volume mode.

Setting the hole diameter of the second engagement hole to be small beforehand is one of effective solutions. However, when the diameter of the second engagement hole is reduced beforehand, such a diameter cannot be decided easily. Plurality of samples with different diameters are prepared, and the sliding friction of each sample is measured. The diameter of the second engagement hole is decided based on the measurement results. Hence, when the diameter is reduced beforehand as described above, the number of designing steps increases, resulting in a cost increase.

Although the head part of the second fin may be eliminated, it is difficult to prevent the fin from being detached from the coupling member when there is no head part.

That is, according to JP H08-113029 A, since the coupling shaft of the second fin is engaged with the enlarged engagement hole, a relatively large gap is produced between this engagement hole and the coupling shaft of the second fin. Since the gap is wide, the second fin may be loosen by such a gap, and thus it is difficult to maintain the second fin at the intended position against the air volume in the more air-volume mode. The term “loosen” means rattling.

JP 2006-015840 A includes a fin provided with vanes, and a coupling member that is rotatably coupled with this fin around a shaft supporting part (a part that supports a shaft).

The shaft support part includes a shaft part provided on either the fin or the coupling member, and a bearing part provided in the other one of the fin and coupling member.

The shaft part includes a substantially cylindrical shaft body, and a head part in a polygonal shape that has at least a part protruding in the radial direction from the shaft body.

The bearing part includes a support plate, and a shaft hole in a polygonal shape which passes completely through the support plate, enables the shaft body to be rotatably fitted (fitted so as to completely pass through) therein, and enables the head part to be fitted therein only at a predetermined position.

By fitting the shaft part in the shaft hole of the bearing part and by rotating the fitted shaft part by a predetermined angle, the fin is rotatably attached to the coupling member. With the fin being rotatably attached to the coupling member, a part of the head part of the shaft part abuts the support plate of the bearing part, thus being retained.

Since the head part is in a polygonal shape, the head part abuts the support plate at more than three portions. When force in the orthogonal direction to the axial direction is applied, the fin is not detached from the coupling member, enabling the fin to stably rotate.

When the coupling body is assembled, the fin is rotated. Rotation of the fin makes the assembling work laborious.

Moreover, as for the rotatable angle of the fin, although a sufficient actuation range is secured as the actuation range in a normal use, the fin is not able to rotate largely when, for example, the fin is fully closed. This decreases the flexibility in designing.

Furthermore, the contact form between the polygonal shape and the cylindrical shape becomes a line contact. When a high sliding friction is preferable, the line contact has a limit. In order to address such a limit, it is necessary to increase the sliding friction by another component and to add an additional component, etc. Adoption of another component increases the costs.

That is, although JP 2006-015840 A can address the looseness of the fin, the structure is complicated which is likely to increase the costs.

Since there is a desire for achieving both the improvement of a product quality and the reduction of production costs, an air conditioning blower hole apparatus is desired which is capable of suppressing a looseness of a fin and of decreasing production costs.

### SUMMARY OF THE INVENTION

An objective of the present disclosure is to provide an air conditioning blower hole apparatus capable of suppressing a looseness of a fin, and of decreasing production costs.

In order to achieve the above objective, an air conditioning blower hole apparatus according to the first embodiment embodiment of the present disclosure includes:

a blower hole panel with a blower hole;

a frame engaged with the blower hole of the blower hole panel;

a plurality of fins rotatably attached to the frame; and

a link coupled with the plurality of fins, the link being configured to simultaneously rotate the plurality of fins,

wherein:

at least one fin among the plurality of fins comprises:

a fin body;

a large-diameter shaft part extending from the fin body;

a small-diameter shaft part extending from the large-diameter shaft part, and having a smaller diameter than a diameter of the large-diameter shaft part; and

a retainer part provided at a tip of the small-diameter shaft part, and having a larger diameter than the small-diameter shaft part,

the link is provided with a large-diameter hole corresponding to the large-diameter shaft part and a small-diameter hole corresponding to the small-diameter shaft part, and

a gap is secured between the small-diameter shaft part and the small-diameter hole.

An air conditioning blower hole apparatus according to the second embodiment of the present disclosure includes:

a blower hole panel with a blower hole;

a plurality of fins rotatably attached to the blower hole of the blower hole panel; and

a link coupled with the plurality of fins, the link being configured to simultaneously rotate the plurality of fins,

wherein:

at least one fin among the plurality of fins comprises:

a fin body;

a large-diameter shaft part extending from the fin body;

a small-diameter shaft part extending from the large-diameter shaft part, and having a smaller diameter than a diameter of the large-diameter shaft part; and

a retainer part provided at a tip of the small-diameter shaft part, and having a larger diameter than the small-diameter shaft part,

the link is provided with a large-diameter hole corresponding to the large-diameter shaft part and a small-diameter hole corresponding to the small-diameter shaft part, and

a gap is secured between the small-diameter shaft part and the small-diameter hole.

In the air conditioning blower hole apparatus according to the above first or second embodiment of the present disclosure, according to the third embodiment of the present disclosure, the large-diameter shaft part and the small-diameter shaft part are each formed in a cylindrical shape.

In the air conditioning blower hole apparatus according to the above first or second embodiment of the present disclosure, according to the fourth embodiment of the present disclosure, the retainer part has a diameter that decreases toward a distal side from the small-diameter shaft part relative to the diameter of the small-diameter shaft part.

In the air conditioning blower hole apparatus according to the above first or second embodiment of the present disclosure, according to the fifth embodiment of the present disclosure:

the link comprises a link body, and a columnar boss partially provided on the link body,

the link body is mainly formed with the small-diameter hole, and

the boss is mainly formed with the large-diameter hole.

According to the above first and second embodiment of the present disclosure, although the small-diameter shaft part of the fin is engaged with the small-diameter hole of the link with the gap, the large-diameter shaft part of the fin is engaged with the large-diameter hole in a contact-slide condition.

The engagement between the large-diameter shaft part and the large-diameter hole suppresses a looseness of the fin.

Moreover, the large-diameter shaft part, the small-diameter shaft part, and the retainer part are provided on the fin, and the link is provided with the large-diameter hole and the small-diameter hole. Hence, the structure of the fin and that of the link are simple, decreasing the production costs.

Therefore, according to the present disclosure, an air conditioning blower hole apparatus is provided which is capable of suppressing a looseness of a fin, and of decreasing production costs.

According to the third embodiment of the present disclosure, the large-diameter shaft part and the small-diameter shaft part are each formed in a cylindrical shape. This increases a contact surface area, easily securing a set sliding friction, and applying a uniform friction when rotated.

Moreover, since the cylindrical shape is a simple shape, a designing of a die is facilitated.

According to the fourth embodiment of the present disclosure, the retainer part is formed in a shape that decreases the diameter toward the tip.

An interference between the retainer part and the small-diameter hole is minimized when the link is assembled. Consequently, a deformation of the small-diameter hole is suppressed, and the assembling is facilitated.

Moreover, since the shape that decreases the diameter toward the tip achieves a guiding action, facilitating the retainer part to enter the small-diameter hole, thereby suppressing a deformation of the small-diameter hole and improving an assembling easiness.

According to the fifth embodiment of the present disclosure, the link includes the link body, and the cylindrical boss partially provided on the link body. Since the portion between the adjacent bosses can be thinned, achieving a weight saving of the link, and a reduction of the necessary amount of a resin material.

### BRIEF DESCRIPTION OF THE DRAWINGS

FIG. 1 is an exploded perspective view of an air conditioning blower hole apparatus according to the present disclosure;

FIG. 2 is a front view of the air conditioning blower hole apparatus according to the present disclosure;

FIG. 3 is a cross-sectional view taken along a line 3-3 in FIG. 2;

FIG. 4 is a cross-sectional view taken along a line 4-4 in FIG. 2;

FIGS. 5A to 5C are diagrams for explaining a shape of a fin and a structure thereof;

FIGS. 6A to 6C are diagrams for explaining a cross-sectional shape in a connection portion between a fin body and a large-diameter shaft part;

FIGS. 7A to 7E are diagrams for explaining a shape of a link and a structure thereof;

FIGS. 8A and 8B are cross-sectional view of the link in a lengthwise direction;

FIGS. 9A to 9D are diagrams for explaining steps of attaching the fin to the link;

FIG. 10 is a diagram illustrating a major portion of the fin attached to the link;

FIGS. 11A to 11C are diagrams for explaining a form of a retainer part;

FIGS. 12A to 12D are cross-sectional views for explaining a form of the link;

FIGS. 13A and 13B are diagrams for explaining a modified example of the large-diameter shaft part; and

FIGS. 14A to 14D are diagrams for explaining a further modified example of the large-diameter shaft part.

### DETAILED DESCRIPTION OF THE EMBODIMENTS

An embodiment of the present disclosure will be described below with reference to the accompanying drawings.

### Embodiment

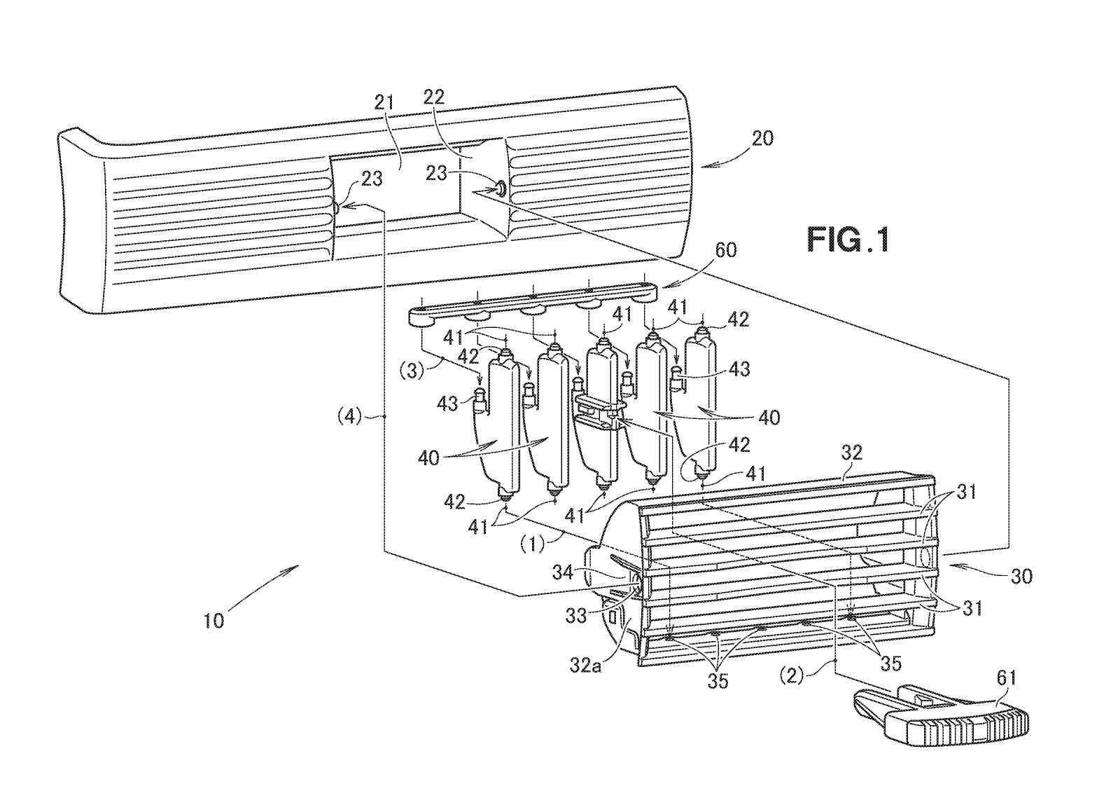

As illustrated in FIG. 1, an air conditioning blower hole apparatus 10 includes a blower hole panel 20 that has a blower hole 21 formed in the front (a surface toward the interior of a vehicle), a fin assembly 30 that has plurality of horizontal fins 31 arranged in parallel with each other, plurality of fins 40 attached to this fin assembly 30, a link 60 that couples these fins 40, and an operation knob 61 attached to one of the plurality of fins 40.

The fins 40 are placed behind the horizontal fins 31 (a distal side from the interior of the vehicle), and is placed vertically so as to be substantially orthogonal to the horizontal fins 31.

The fins 40 are attached to the fin assembly 30 so as to be rotatable around respective axial lines 41 in parallel with each other.

The link 60 extends in the direction in which the plurality of fins 40 are placed. The fins 40 are rotatable relative to the link 60.

The blower hole panel 20 has a rectangular cylindrical part 22, and an end of this cylindrical part 22 at the vehicle-interior side serves as the blower hole 21, and includes a pair of engagement pins 23, 23.

The fin assembly 30 includes the plurality of (e.g., four) horizontal fins 31 which are substantially horizontal to a rectangular cylindrical frame 32, and which extend in parallel with each other, and includes respective engagement recesses 33 formed in right and left side faces 32a of the frame 32 and also respective guides 34 thereon to guide the respective engagement pins 23 to the respective engagement recesses 33.

Although the detailed structure of the fins 40 and that of the link 60 will be described later, as indicated by an arrow (1), a support shaft 42 of each fin 40 is engaged with a hole (or recess) 35 formed in the frame 32 of the fin assembly 30, and thus each fin 40 is attached vertically and rotatably relative to the frame 32.

Next, as indicated by an arrow (2), the operation knob 61 is engaged with the one fin 40 so as to pass through between the upper and lower horizontal fins 31, 31.

Moreover, as indicated by an arrow (3), the link 60 is attached to each small-diameter shaft part 43 of the fins 40. It is adequate if the attachment work indicated by the arrow (2) is executed after the attachment work indicated by the arrow (3).

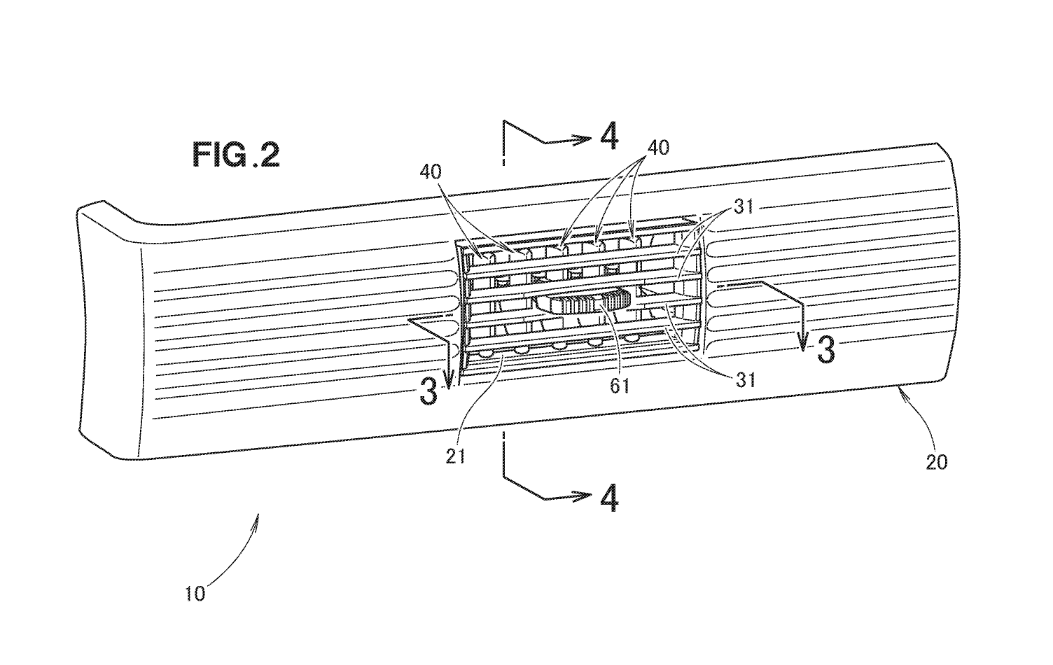

Eventually, as indicated by an arrow (4), the respective engagement pins 23 are fitted in the respective engagement recesses 33, thereby attaching the fin assembly 30 to the blower hole 21. FIG. 2 illustrates the finished assembling.

As illustrated in FIG. 2, the air conditioning blower hole apparatus 10 is, for example, a resin-made product elongated in the horizontal direction, and a part of the operation knob 61 protrudes from between the upper and lower horizontal fins 31 and 31.

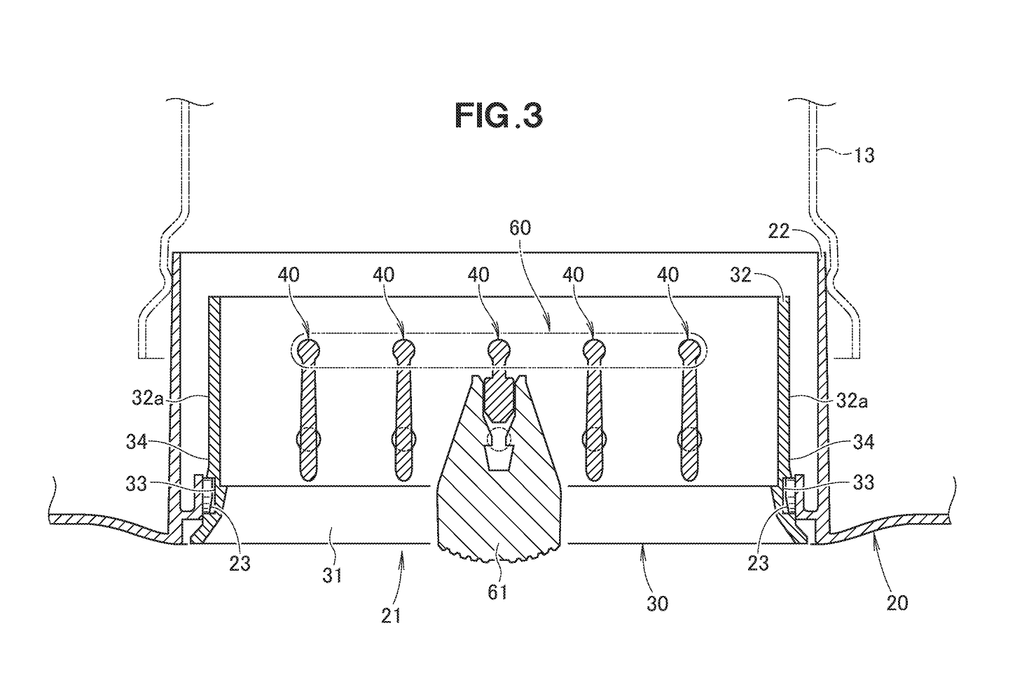

As illustrated in FIG. 3 that is a cross-sectional view taken along a line 3-3 in FIG. 2, the engagement recess 33 and the guide 34 extending backwardly from this engagement recess 33 are provided at each of the right and left side faces 32a of the frame 32.

In contrast, in the blower hole panel 20, the respective engagement pins 23 to be engaged with the respective engagement recesses 33 are provided on the respective side faces of the cylindrical part 22.

When it is attempted to engage the fin assembly 30 with the cylindrical part 22 through the blower hole 21, the respective engagement pins 23 are guided by the respective guides 34, and are engaged with the respective engagement recesses 33 so as to go over the respective guides 34, and thus the fin assembly 30 is attached to the blower hole panel 20.

Moreover, since the link 60 is linked with the plurality of fins 40, when the one fin 40 is rotated by the operation knob 61, the remaining fins 40 are synchronously rotated.

Although the operation knob 61 is coupled so as to be rotatable around the axial line of the fins 40, a structure in which the operation knob contact-slides against the one horizontal fin 31 is also applicable.

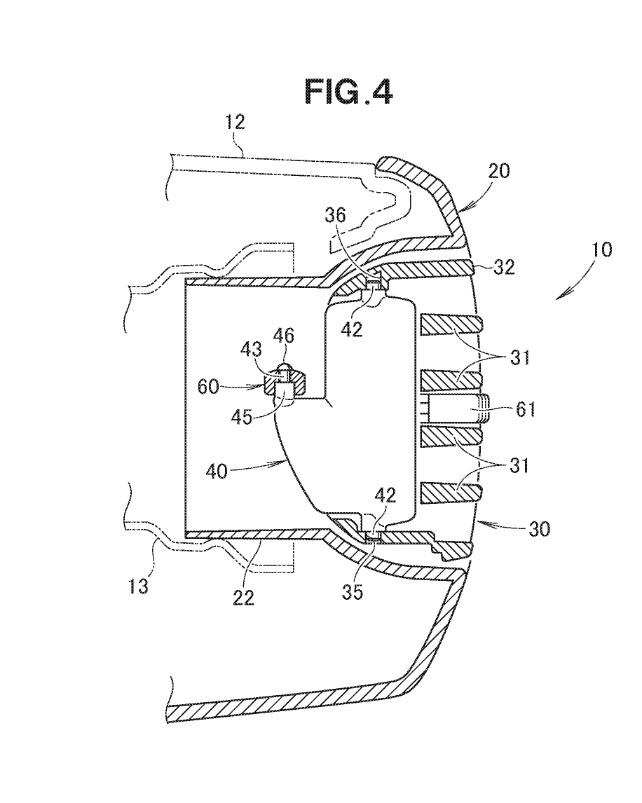

As illustrated in FIG. 4, the air conditioning blower hole apparatus 10 is provided at a location near, for example, a side door at the driver-seat side in an instrument panel 12 which is a support panel placed in the interior of the vehicle and which is formed of a synthetic resin.

The blower hole panel 20 that is one of the components of this air conditioning blower hole apparatus 10 corresponds to an upholstery panel attached to the instrument panel 12.

The cylindrical part 22 at the blower-hole-panel-20 side is extended toward the forward side of the vehicle, and is fitted in a duct 13. This causes the blower hole panel 20 and the duct 13 to be connected with each other, and conditioned air produced by an air conditioning apparatus is sent to the blower hole panel 20 via the duct 13, and is blown out to the interior of the vehicle.

Each fin 40 has the upper support shaft 42 engaged with a recess 36 provided in the frame 32, and has the lower support shaft 42 engaged with the hole 35 provided in the frame 32. Hence, the fins 40 are supported by the fin assembly 30 so as to be rotatable around the upper and lower support shafts 42.

When the frame 32 of the fin assembly 30 is pushed manually, the entire fin assembly 30 rotates around the engagement pins (see FIG. 1, reference numerals 23 and 23). This rotation enables an arbitrary blowing configuration, such as upward blowing, horizontal blowing, or downward blowing.

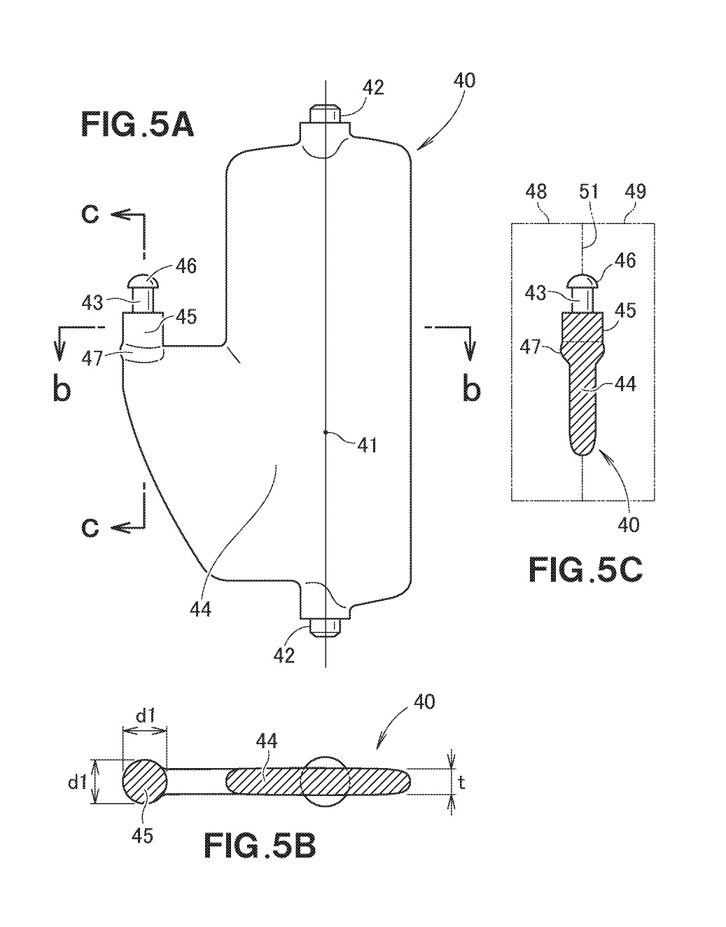

The form of the fins 40 and the structure thereof will be described in detail with reference to FIGS. 5A to 5C.

As illustrated in FIG. 5A, each fin 40 includes a fin body 44 that has the upper and lower support shafts 42 and 42, and the small-diameter shaft part 43 which is in parallel with the support shaft 42 (an axial line 41), and which extends from the fin body 44.

However, the small-diameter shaft part 43 is not directly connected to the fin body 44.

That is, a large-diameter shaft part 45 is provided which extends toward the fin body 44 from the small-diameter shaft part 43, and which has a larger outer diameter or width in the orthogonal direction to the axial direction than that of the small-diameter shaft part 43, and a retainer part 46 that retains the link (see FIG. 4, reference numeral 60) is provided at a tip of the small-diameter shaft part 43.

As illustrated in FIG. 5B that is a cross-sectional view taken along a line b-b in FIG. 5A, an outer diameter (or width) d1 of the large-diameter shaft part 45 is set to be (1.1 to 2.0) times as much as a thickness t of the fin body 44.

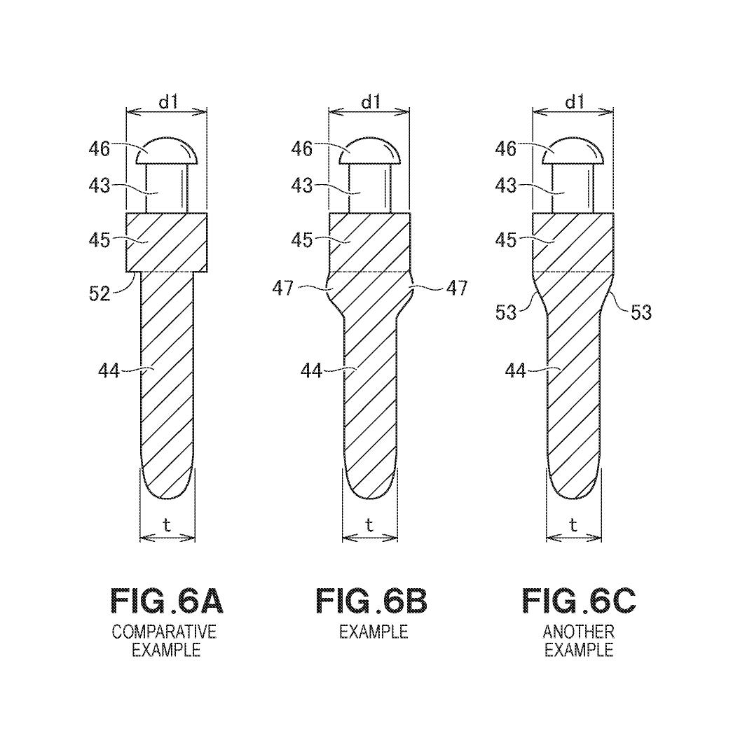

As illustrated in FIG. 5C that is a cross-sectional view taken along a line c-c in FIG. 5A, the fin body 44 and the large-diameter shaft part 45 are connected with each other via an expanding part 47 that has a larger diameter (or width) than the outer diameter of the large-diameter shaft part 45. The advantage of the expanding part 47 will be described with reference to FIGS. 6A to 6C.

The fins 40 are resin-molded by a left die 48 and a right die 49 illustrated in FIG. 5C. By opening the left die 48 and the right die 49 at a die abutting surface 51 called a parting line, the fins 40 are taken out.

The action of the expanding part 47 will be described with reference to FIGS. 6A to 6C.

According to a comparative example illustrated in FIG. 6A, a lower stepped part 52 is formed between the fin body 44 that has a thickness t and the large-diameter shaft part 45 that has a larger outer diameter d1 (or width) than the thickness t. Since the cross-sectional dimension suddenly changes, at the time of injection molding, a defect like a void is likely to be formed at the joined portion of the stepped part 52 because of an uneven flow of resin.

Since operation force is applied horizontally to the large-diameter shaft part 45 from the link (see FIG. 4, reference numeral 60), when the stepped part 52 has a defect at the joined portion, a failure may occur such that a crack advances from the defect.

In this point, according to the example as illustrated in FIG. 6B, the fin body 44 and the large-diameter shaft part 45 are connected with each other via the expanding part 47 that has a larger width than the outer diameter (or width) d1 of the large-diameter shaft part 45. Since the expanding part 47 with a larger width provided at the boundary between the fin body 44 and the large-diameter shaft part 45 secures a smooth flow of the resin and a resin amount, a possibility such that a defect like a void occurs at the boundary between the fin body 44 and the large-diameter shaft part 45 is reduced. Hence, a strength at the boundary between the fin body 44 and the large-diameter shaft part 45 is secured.

Moreover, as illustrated in another example as illustrated in FIG. 6C, the fin body 44 and the large-diameter shaft part 45 may be connected with each other via a cross-section gradually changing part 53 that gradually changes a cross-sectional dimension. The lower end of the cross-section gradually changing part 53 has the same thickness as the thickness t of the fin body 44, and the upper end of the cross-section gradually changing part 53 has the same diameter as the outer diameter (or width) d1 of the large-diameter shaft part 45.

Since the cross-sectional dimension gradually changes at the cross-section gradually changing part 53, a defect like a void is not likely to occur.

In the case of FIG. 6C, since the cross-sectional shape is simplified in comparison with that of FIG. 6B, the designing of the die applied for resin molding is facilitated.

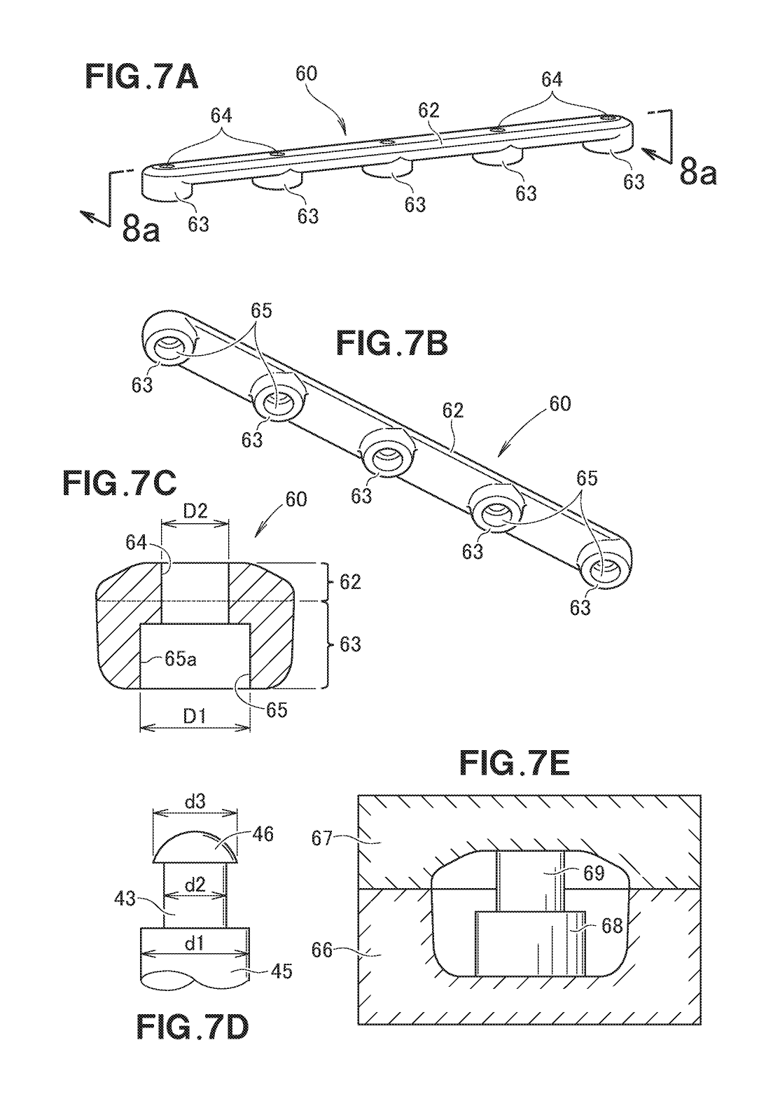

Next, an example shape of the link 60 and a structure thereof will be described with reference to FIGS. 7A to 7E.

As illustrated in FIG. 7A, the link 60 includes an elongated plate shape link body 62, and columnar bosses 63 provided partially in the link body 62. When the link body 62 is seen from a top, respective ends of small-diameter holes 64 can be seen.

As illustrated in FIG. 7B that is equivalent to a bottom view, when the bosses 63 are seen from the bottom, respective ends of large-diameter holes 65 can be seen.

As illustrated in FIG. 7C that is a cross-sectional view of the link 60, formed continuously in the link 60 are the large-diameter hole 65 to be engaged with the large-diameter shaft part 45, and the small-diameter hole 64 to be engaged with the small-diameter shaft part 43.

A hole diameter (or width) D1 of the large-diameter hole 65 is sufficiently larger than a hole diameter (or width) D2 of the small-diameter hole 64. The inner circumference of the large-diameter hole 65 serves as a contact-slide surface 65a.

In this example, the whole large-diameter hole 65 and a part of the small-diameter hole 64 are formed in the boss 63, and the remaining part of the small-diameter hole 64 is formed in the link body 62. However, only the large-diameter hole 65 may be formed in the boss 63, only the small-diameter hole 64 may be formed in the link body 62, the whole small-diameter hole 64 and a part of the large-diameter hole 65 may be formed in the link body 62, and the remaining part of the large-diameter hole 65 may be formed in the boss 63.

In order to cover all configurations as described above, the small-diameter hole 64 is mainly formed in the link body 62, and the large-diameter hole 65 is mainly formed in the boss 63.

Corresponding to the link 60, the small-diameter shaft part 43, etc., is illustrated in FIG. 7D. The outer diameter (or width) of the large-diameter shaft part 45 is defined as d1, the outer diameter (or width) of the small-diameter shaft part 43 is defined as d2, and the outer diameter (or width) of the retainer part 46 is defined as d3.

In this case, d1 is set to be substantially equal to D1. Moreover, setting such that d2<d3<d1 is made. In this case, d2 and d3 both become smaller than D1.

Moreover, D2 is set to be larger than d2 and smaller than d3.

As illustrated in FIG. 7E, the link 60 is resin-molded by a lower die 66 and an upper die 67. In this example, a large-diameter pin 68 to form the large-diameter hole 65, and a small-diameter pin 69 to form the small-diameter hole 64 are integrally formed with the lower die 66. A melted resin material is injected via a cavity, and when the resin material is cured, the lower die 66 and the upper die 67 are opened, and the link 60 is taken out.

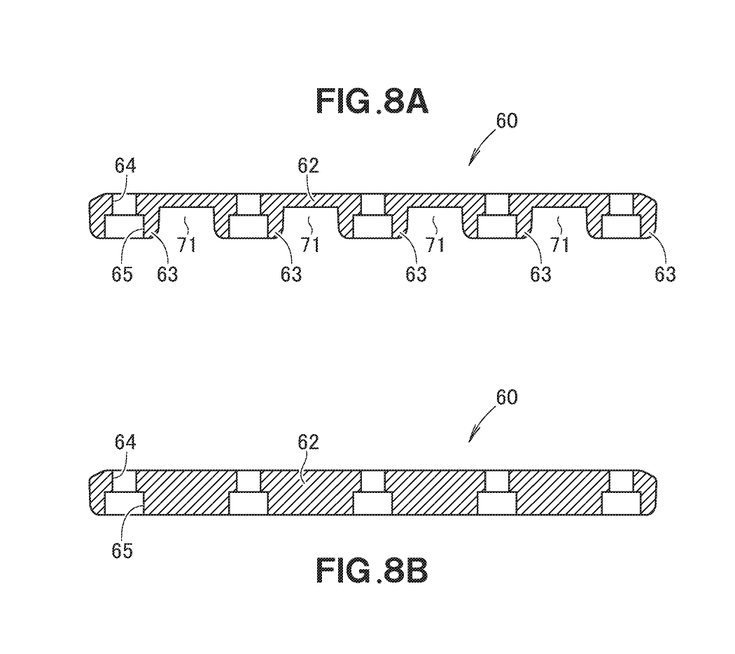

FIG. 8A is a cross-sectional view taken along a line 8a-8a in FIG. 7A. FIG. 8B illustrates a modified example.

As illustrated in FIG. 8B, the link 60 may include only the link body 62 with a thickness that covers the boss 63. This facilitates a designing of the die.

However, the link 60 illustrated in FIG. 8A has advantages such that a thinned part 71 can be formed between the adjacent bosses 63, enabling a weight saving.

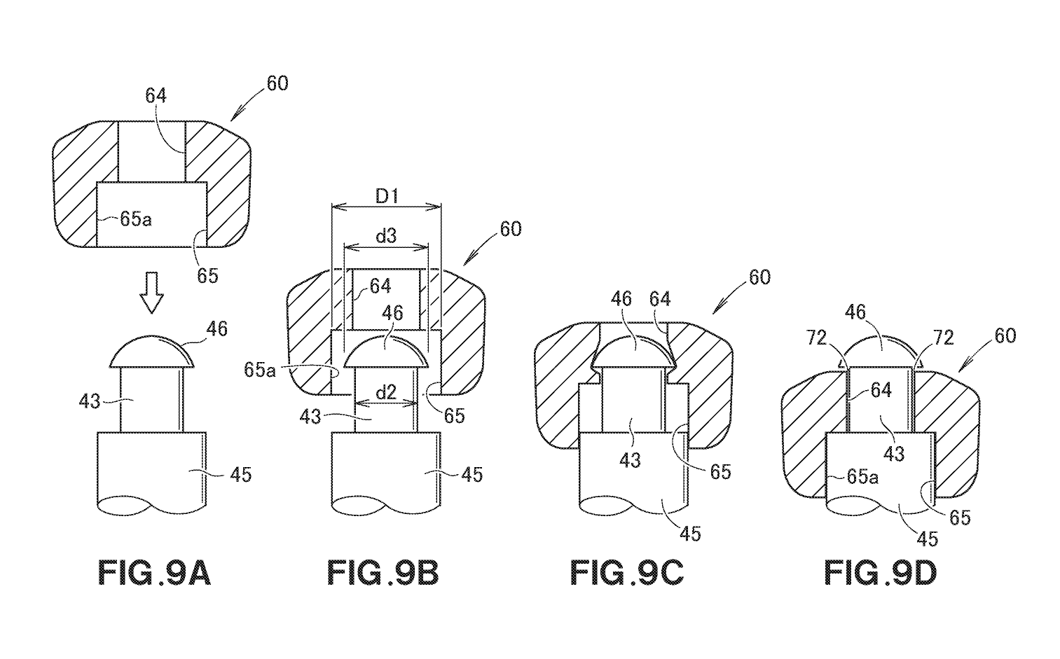

Next, the details of attaching procedures of the link 60 to the fins 40 will be described with reference to FIGS. 9A to 9D.

As illustrated in FIG. 9A, the link 60 is moved (moved down) relative to the small-diameter shaft part 43 with the retainer part 46 being directed upwardly. Since this is a relative movement, it is adequate if the small-diameter shaft part 43 is moved (moved up) to the stationary link 60.

As illustrated in FIG. 9B, since d2<d3<D1, the retainer part 46 and the small-diameter shaft part 43 enter the large-diameter hole 65 without being in contact with the contact-slide surface 65a. Since the retainer part 46 and the small-diameter shaft part 43 do not contact the contact-slide surface 65a, an occasion in which the contact-slide surface 65a becomes rough is avoidable.

If the contact-slide surface 65a becomes rough, in FIG. 9D to be described later, the frictional coefficient between the large-diameter shaft part 45 and the contact-slide surface 65a is changed or varies, and thus it becomes difficult to obtain a desired sliding friction.

In this point, according to this example, since the contact-slide surface 65a is still flat, a desired sliding friction is easily obtained.

That is, as illustrated in FIG. 9B, since the small-diameter shaft part 43 and the retainer part 46 do not contact the contact-slide surface 65a at the time of assembling and this does not affect the surface of the contact-slide surface 65a and the large-diameter shaft part 45, the sliding friction can be easily adjusted. In general, adjustment of the outer diameter (or width) of the large-diameter shaft part 45 or the diameter (or width) of the large-diameter hole 65 is repeatedly performed until a desired sliding friction is achieved. The refined sliding friction is achieved by this repeated adjustment. According to the present disclosure, since the sliding friction can be easily adjusted, the number of refining steps and the costs can be reduced.

When the link 60 abuts the retainer part 46, the link 60 is pushed downward and intensively. Since the retainer part 46 is in a shape that decreases the diameter toward the tip (in this example, the upper end), the retainer part 46 enters the small-diameter hole 64.

As illustrated in FIG. 9C, while the small-diameter hole 64 has the diameter increased by the retainer part 46, the link 60 goes down. Since the link 60 is formed of a resin and is capable of elastically deforming, after the diameter is increased by the retainer part 46, the diameter decreases. However, since the effect of the deformation remains, the diameter after the diameter has been decreased is slightly larger than the diameter before the diameter has been increased.

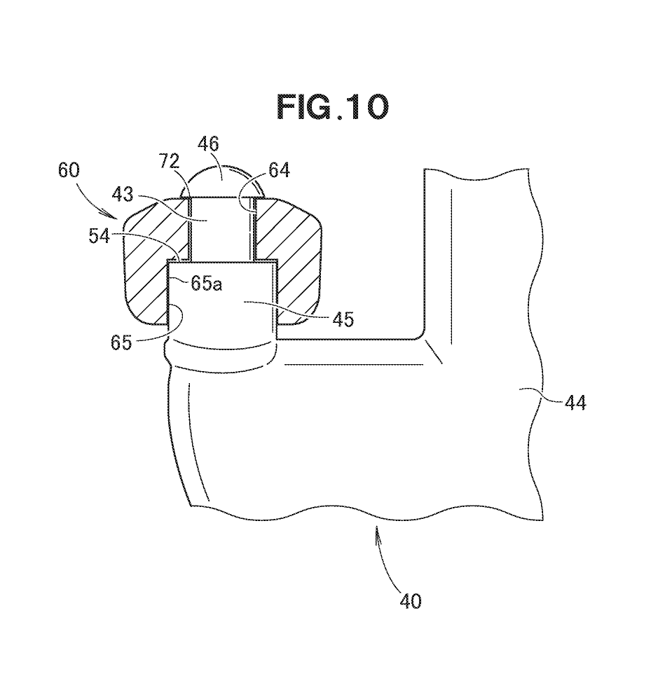

As illustrated in FIG. 9D, a relatively large gap 72 is formed between the small-diameter shaft part 43 and the small-diameter hole 64. In contrast, the large-diameter shaft part 45 is engaged with the large-diameter hole 65 with substantially no gap. The configuration after the engagement is illustrated in FIG. 10.

As illustrated in FIG. 10, the large-diameter shaft part 45 is engaged with the large-diameter hole 65, and the small-diameter shaft part 43 is engaged with the small-diameter hole 64.

The link 60 moves in the back-and-forth direction of the figure. At the time of this movement, the link 60 may move upwardly or downwardly. The upward movement is restricted by the retainer part 46, while the downward movement is restricted by an upper surface seat 54 of the large-diameter shaft part 45.

Moreover, a movement of the link 60 transmits force to the large-diameter shaft part 45 from the link 60. A frictional force (sliding friction) obtained by multiplying this force by a frictional coefficient is produced on the contact-slide surface 65a of the large-diameter hole 65.

Even if rotation force is applied to the fins 40 by the blown air by the air conditioner, the large-diameter hole 65 is snugly engaged with the large-diameter shaft part 45 and a moderate sliding friction is produced on the contact-slide surface 65a, the fins 40 are held by the link 60, thereby suppressing a looseness of the fins 40.

It is important to set the contact-slide resistance produced between the large-diameter shaft part 45 and the contact-slide surface 65a to be an appropriate value.

The sliding friction is correctable by changing the outer diameter (or width) of the large-diameter shaft part 45, or the hole diameter (or width) of the large-diameter hole 65.

More specifically, the outer diameter (or width) of the large-diameter shaft part 45 can be changed by correcting the left die 48 and the right die 49 that are illustrated in FIG. 5C. Alternatively, the hole diameter (or width) of the large-diameter hole 65 can be changed by modifying the large-diameter pin 68 of the lower die 66 that is illustrated in FIG. 7E.

Although any modification scheme is applicable, since it is necessary to modify both the left die 48 and the right die 49 to change the outer diameter (or width) of the large-diameter shaft part 45, costs for modifying the dies increase. In contrast, when the hole diameter (or width) of the large-diameter hole 65 is changed, it is appropriate if only the lower die 66 is modified, thus reducing an increase in costs for modifying the die.

Accordingly, modification of the large-diameter hole 65 is rather suitable than modification of the large-diameter shaft part 45.

According to the present disclosure, the gap 72 is secured between the small-diameter shaft part 43 and the small-diameter hole 64, and the small-diameter shaft part 43 does not contribute for transmission of force and production of frictional force. As illustrated in FIG. 9C, the small-diameter hole 64 has the diameter increased by the retainer part 46, and it is adequate if the finished hole diameter of the small-diameter hole 64 in FIG. 9D varies. Even if scratches, etc., remain on the inner circumference of the small-diameter hole 64, such scratches do not cause a problem. This facilitates an attachment work of the small-diameter shaft part 43 to the link 60.

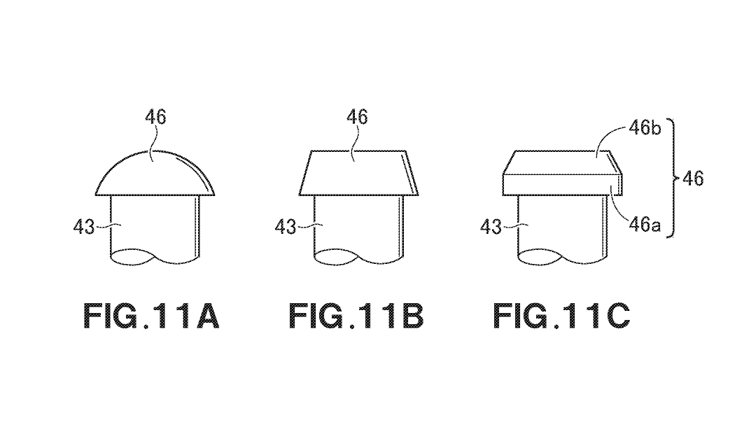

Various configurations of the retainer part 46 will described with reference to FIGS. 11A to 11C.

As illustrated in FIG. 11A, the retainer part 46 is formed in a shape which includes a partial spherical portion, is rounded and decreases the diameter toward the tip.

As illustrated in FIG. 11B, the retainer part 46 is formed in a circular cone trapezoidal shape, and decreases the diameter toward the tip.

As illustrated in FIG. 11C, the retainer part 46 includes a cylindrical part 46a, and a circular cone trapezoid 46b formed integrally on the cylindrical part 46a, and decreases the diameter toward the tip.

As illustrated in FIGS. 11A to 11C, the retainer part 46 in the shape that decreases the diameter toward the tip may be tapered, or may be in other similar shapes than the shapes in FIGS. 11A to 11C, and such a shape is not limited to the embodiment.

The retainer part 46 is in the shape that decreases the diameter toward the tip, when the link 60 is assembled, the interference between the retainer part 46 and the small-diameter hole 64 is minimized. This prevents the small-diameter hole 64 from being deformed, and improves the assembling easiness.

Moreover, since the shape that decreases the diameter toward the tip achieves a guiding action, facilitating the retainer part 46 to enter the small-diameter hole 64, thereby achieving both the deformation prevention of the small-diameter hole 64 and the improvement of the assembling easiness.

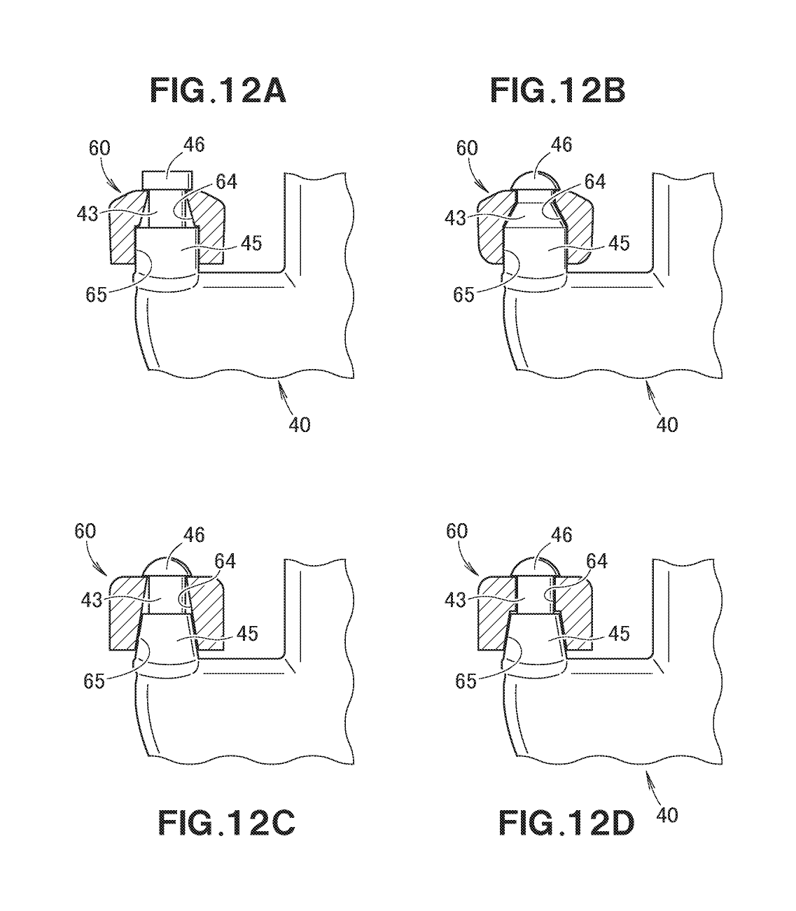

Next, various configurations of the large-diameter shaft part 45 will be described with reference to FIGS. 12A to 12D.

As illustrated in FIG. 12A, the cylindrical small-diameter shaft part 43 may be formed so as to be continuous from the cylindrical large-diameter shaft part 45, and the retainer part 46 in a circular plate (flat plate) shape may be integrally formed with the tip of this small-diameter shaft part 43.

This shape is suitable when the small-diameter hole 64 of the link 60 is a tapered hole that increases the diameter downwardly. The tapered hole achieves the guiding action that guides the retainer part 46.

As illustrated in FIG. 12B, the small-diameter shaft part 43 which has a lower half part in a circular cone trapezoidal shape and has an upper part in a cylindrical shape may be formed so as to be continuous from the cylindrical large-diameter shaft part 45, and the retainer part 46 may be integrally formed with the tip of this small-diameter shaft part 43.

This shape is suitable when the small-diameter hole 64 of the link 60 is a combination of a tapered hole and a cylindrical hole continuous from each other.

As illustrated in FIG. 12C, the cylindrical small-diameter shaft part 43 may be formed so as to be continuous from the circular cone trapezoidal large-diameter shaft part 45, and the retainer part 46 may be integrally formed with the tip of this small-diameter shaft part 43.

This shape is suitable when the large-diameter hole 65 and the small-diameter hole 64 of the link 60 are continuous tapered holes. Since it is a tapered hole, in comparison with a cylindrical hole, the contact-slide surface area is large, and thus a stabilization of the sliding friction is expected.

As illustrated in FIG. 12D, the cylindrical small-diameter shaft part 43 may be formed so as to be continuous from the circular cone trapezoidal large-diameter shaft part 45, and the retainer part 46 may be formed integrally with the tip of this small-diameter shaft part 43.

This shape is suitable when the large-diameter hole 65 of the link 60 is a tapered hole. Since it is a tapered hole, in comparison with a cylindrical hole, the contact-slide surface area is large, and thus a stabilization of the sliding friction is expected.

As described above, the large-diameter shaft part 45 is not limited to a cylindrical shape, and may be a circular cone trapezoidal shape. Similarly, the small-diameter shaft part 43 is not limited to a cylindrical shape, and may be a circular cone trapezoidal shape.

In examples illustrated in FIGS. 12C and 12D, the link 60 is likely to be raised by the circular cone trapezoidal large-diameter shaft part 45. Upward force is applied to the retainer part 46 when the link is raised.

In view of a reduction of load to be applied to the retainer part 46, the examples illustrated in FIG. 12A and FIG. 12B are more preferable which prevents the link 60 from being raised than the examples illustrated in FIG. 12C and FIG. 12D.

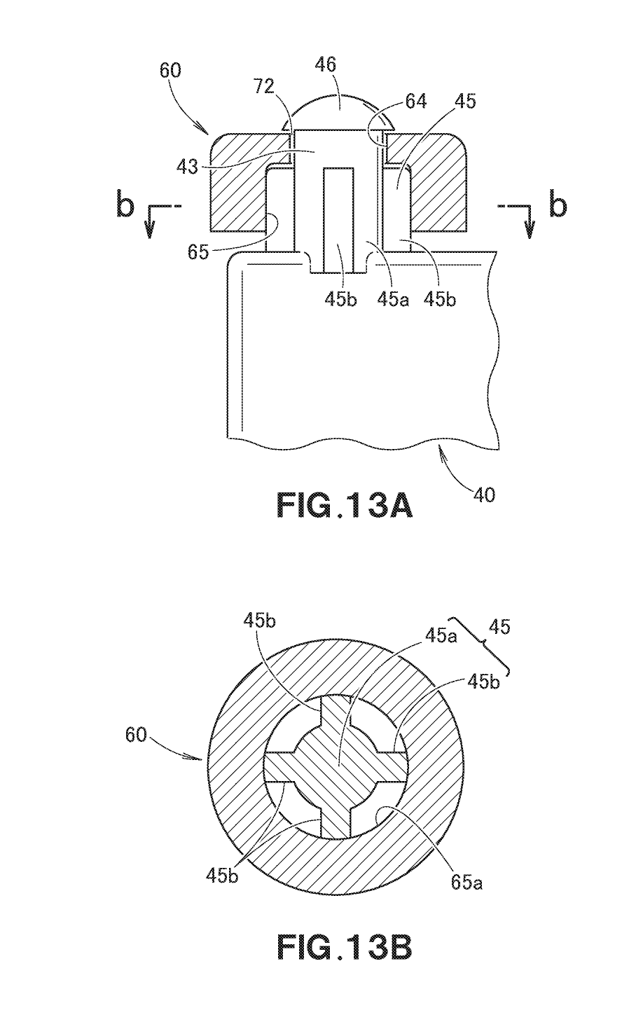

Next, a modified example of the large-diameter shaft part 45 will be described with reference to FIGS. 13A and 13B.

As illustrated in FIG. 13B that is a cross-sectional view taken along a line b-b in FIG. 13A, the large-diameter shaft part 45 includes a columnar part 45a, and plurality of projections 45b that radially project from this columnar part 45a, and the plurality of projections 45b are in contact with the contact-slide surface 65a. In this example, although the four projections 45b are provided at the pitch that is for each 90 degree, the number of projections is not limited to this example. Since the portion between the adjacent projections 45b are eliminated, weight saving of the large-diameter shaft part 45 is achieved.

As illustrated in FIG. 13A, the large-diameter shaft part 45 is engaged with the large-diameter hole 65, and the small-diameter shaft part 43 is engaged with the small-diameter hole 64 with the gap 72.

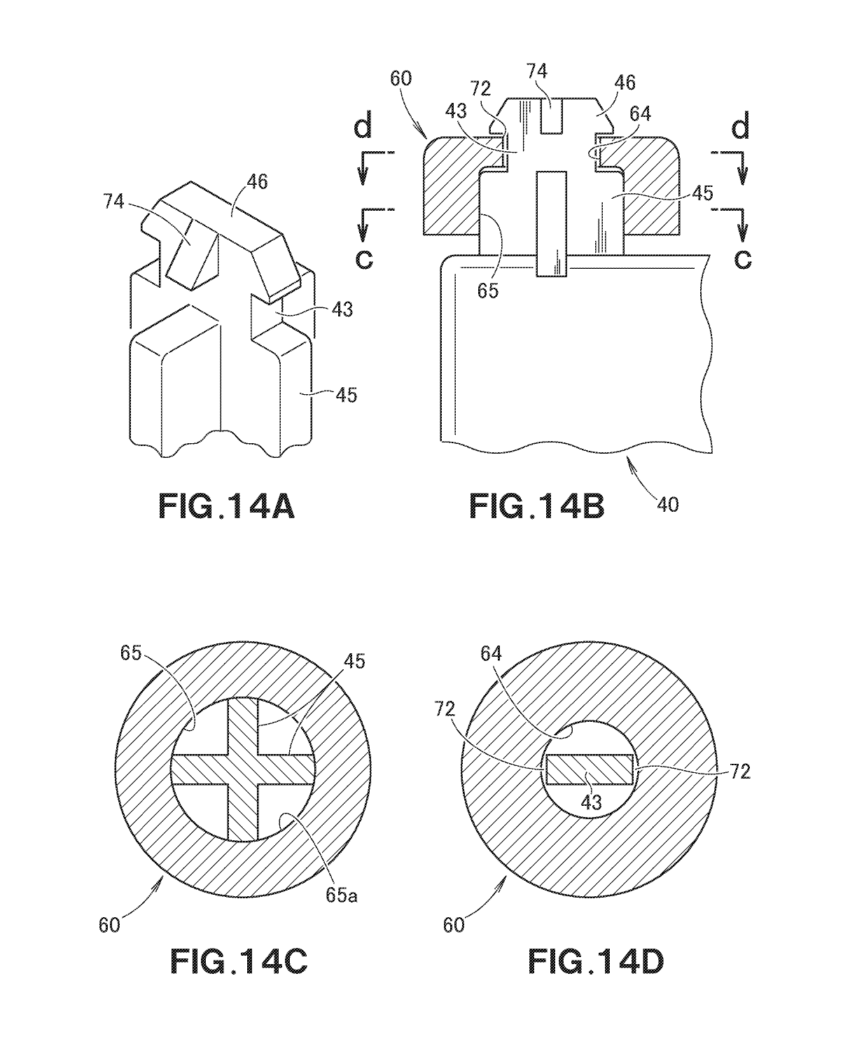

A further modified example of the large-diameter shaft part 45 will be described with reference to FIGS. 14A to 14D.

As illustrated in FIG. 14A, the plate-shape small-diameter shaft part 43 is formed so as to be continuous from the large-diameter shaft part 45 in a cross shape by two plates, and the trapezoidal retainer part 46 is integrally formed with this small-diameter shaft part 43.

Preferably, pawls 74 each in a triangular shape are integrally formed with both the side faces of the trapezoidal retainer part 46, respectively.

As illustrated in FIG. 14B, the large-diameter shaft part 45 is engaged with the large-diameter hole 65, and the small-diameter shaft part 43 is engaged with the small-diameter hole 64 with the gap 72.

As illustrated in FIG. 14C that is a cross-sectional view taken along a line c-c in FIG. 14B, the large-diameter shaft part 45 in the cross shape is engaged with the large-diameter hole 65, and a sufficient frictional force against the contact-slide surface 65a is produced.

As illustrated in FIG. 14D that is a cross-sectional view taken along a line d-d in FIG. 14B, the small-diameter shaft part 43 with a rectangular cross-section is disposed within the small-diameter hole 64 with the gap 72.

As illustrated in FIGS. 13A and 13B, the large-diameter shaft part 45 is not limited to an axial shape. Moreover, as illustrated in FIGS. 14A to 14D, the small-diameter shaft part 43 is not limited to an axial shape.

Although it is desirable to provide the large-diameter shaft part 45, the small-diameter shaft part 43 and the retainer part 46 on all the five fins 40 illustrated in FIG. 1, it is adequate if the large-diameter shaft part 45 and the retainer part 46 are provided on only some of the fins 40.

More specifically, the large-diameter shaft part 45, the small-diameter shaft part 43, and the retainer part 46 may be provided on only one fin 40 (e.g., the center fin) among the five fins 40, and only the respective small-diameter shaft parts 43 may be provided on the remaining fins 40. This enables an omission of the large-diameter shaft part 45 and the retainer part 46 for the remaining fins 40. In this case, it is appropriate if the sliding friction is produced by decreasing the diameter of the small-diameter hole 64, or by increasing the diameter of the small-diameter shaft part 43. Alternatively, it is appropriate if the sliding friction is produced by decreasing the diameter of the hole 35 or the recess 36, or by increasing the diameter of the support shaft 42.

Alternatively, the respective large-diameter shaft parts 45, the respective small-diameter shaft parts 43, and the respective retainer parts 46 may be provided on the two fins 40 (e.g., the leftmost fin and the rightmost fin) among the five fins 40, and the respective small-diameter shaft parts 43 may be provided on the remaining three fins 40.

Alternatively, the respective large-diameter shaft parts 45, the respective small-diameter shaft parts 43, and the respective retainer parts 46 may be provided on the three fins 40 (e.g., the center fin, the leftmost fin, and the rightmost fin) among the five fins 40, and the respective small-diameter shaft parts 43 may be provided on the remaining two fins 40.

Alternatively, the respective large-diameter shaft parts 45, the respective small-diameter shaft parts 43, and the respective retainer parts 46 may be provided on the four fins 40 (e.g., the four fins other than the center fin) among the five fins 40, and the small-diameter shaft part 43 may be provided on the remaining one fin 40 (the center fin).

Hence, it is appropriate if the large-diameter shaft part 45, the small-diameter shaft part 43, and the retainer part 46 is provided on at least one of the five fins 40.

Moreover, although the embodiment illustrated in FIG. 4 has the fins 40 axially supported by the frame 32 of the fin assembly 30, the fins 40 may be axially supported by the cylindrical part 22 of the blower hole panel 20.

Furthermore, the blower hole panel 20 and the cylindrical part 22 may be separate components from each other.

Still further, according to the embodiment illustrated in FIG. 1, the plurality of horizontal fins 31 are fastened to the frame 32 of the fin assembly 30. However, each of the plurality of horizontal fins 31 may be rotatably supported by a suitable holding member, and the holding member may be assembled with the duct 13, etc. In addition, the respective rotatable horizontal fins 31 may be coupled by a vertical link, and an appropriate knob may be attached to such a link, and the angle of the horizontal fins 31 may be adjusted by a manual operation to the knob.

Yet still further, in the embodiment illustrated in FIG. 1, the fins 40 may be rotated upside down, and the link 60 may be attached to the small-diameter shaft part 43 that extends downwardly.

Since the blower hole is elongated in the horizontal direction according to this embodiment, the direction in which the fins 40 are arranged is the horizontal direction. However, the present disclosure is applicable to the blower hole 21 which is elongated in the vertical direction and which has the fins 40 arranged in the vertical direction.

### INDUSTRIAL AVAILABILITY

The present disclosure is applicable to an air conditioning blower hole apparatus that adjusts the direction of blown air by rotating the plurality of fins via a link.

What is claimed is:

1. An air conditioning blower hole apparatus comprising:
a blower hole panel with a blower hole;
a frame engaged with the blower hole of the blower hole panel;
a plurality of fins rotatably attached to the frame; and
a link coupled with the plurality of fins, the link being configured to simultaneously rotate the plurality of fins,
wherein:
at least one fin among the plurality of fins comprises:
a fin body;
a large-diameter shaft part extending from the fin body;
a small-diameter shaft part extending from the large-diameter shaft part, and having a smaller diameter than a diameter of the large-diameter shaft part; and
a retainer part provided at a tip of the small-diameter shaft part, and having a larger diameter than the small-diameter shaft part,
the link is provided with a large-diameter hole corresponding to the large-diameter shaft part and a small-diameter hole corresponding to the small-diameter shaft part, and
a gap is secured between the small-diameter shaft part and the small-diameter hole.

2. An air conditioning blower hole apparatus comprising:
a blower hole panel with a blower hole;
a plurality of fins rotatably attached to the blower hole of the blower hole panel; and
a link coupled with the plurality of fins, the link being configured to simultaneously rotate the plurality of fins,
wherein:
at least one fin among the plurality of fins comprises:
a fin body;
a large-diameter shaft part extending from the fin body;
a small-diameter shaft part extending from the large-diameter shaft part, and having a smaller diameter than a diameter of the large-diameter shaft part; and
a retainer part provided at a tip of the small-diameter shaft part, and having a larger diameter than the small-diameter shaft part,
the link is provided with a large-diameter hole corresponding to the large-diameter shaft part and a small-diameter hole corresponding to the small-diameter shaft part, and
a gap is secured between the small-diameter shaft part and the small-diameter hole.

3. The air conditioning blower hole apparatus according to claim 1, wherein the large-diameter shaft part and the small-diameter shaft part are each formed in a cylindrical shape.

4. The air conditioning blower hole apparatus according to claim 2, wherein the large-diameter shaft part and the small-diameter shaft part are each formed in a cylindrical shape.

5. The air conditioning blower hole apparatus according to claim 1, wherein the retainer part has a diameter that decreases toward a distal side from the small-diameter shaft part relative to the diameter of the small-diameter shaft part.

6. The air conditioning blower hole apparatus according to claim 2, wherein the retainer part has a diameter that decreases toward a distal side from the small-diameter shaft part relative to the diameter of the small-diameter shaft part.

7. The air conditioning blower hole apparatus according to claim 1, wherein:
the link comprises a link body, and a columnar boss partially provided on the link body,
the link body is mainly formed with the small-diameter hole, and
the boss is mainly formed with the large-diameter hole.

8. The air conditioning blower hole apparatus according to claim 2, wherein:
the link comprises a link body, and a columnar boss partially provided on the link body,
the link body is mainly formed with the small-diameter hole, and
the boss is mainly formed with the large-diameter hole.
